(19) United States
(12) Patent Application Publication
(10) Pub. No.: US 2002/0010026 A1
(43) Pub. Date: Jan. 24, 2002

(54) Multiplayer video game enhancer

(76) Inventor: Keith York, Sacramento, CA (US)

Correspondence Address: Keith York, 9125 Clendenen Way, Sacramento, CA, 95826, US

(21) Appl. No.: 09/850,874

(22) Filed: May 7, 2001

Related U.S. Application Data
(60) Provisional application No. 60/202,816, filed on May 8, 2000.

(51) Int. Cl. A63F 13/00

(52) U.S. Cl. 463/47

(57) ABSTRACT

A game apparatus for console video game players used as a temporary attachment to one's television set. It consists of a main body and an extending arm, used to erect a flag from the front face of the viewing monitor. The arm is pivotally connected to the central body allowing for angular rotation relative to the face of the television screen. A weighted block is used to offset the relative force of gravity upon the blinder/flag portion, thereby stabilizing the device for extended use. Provides an effective means of blocking the viewing angle of either opponent from one another, suitable for a majority of televisions. Rotating arm useful to allow normal seating positions for different sized/shaped living rooms.

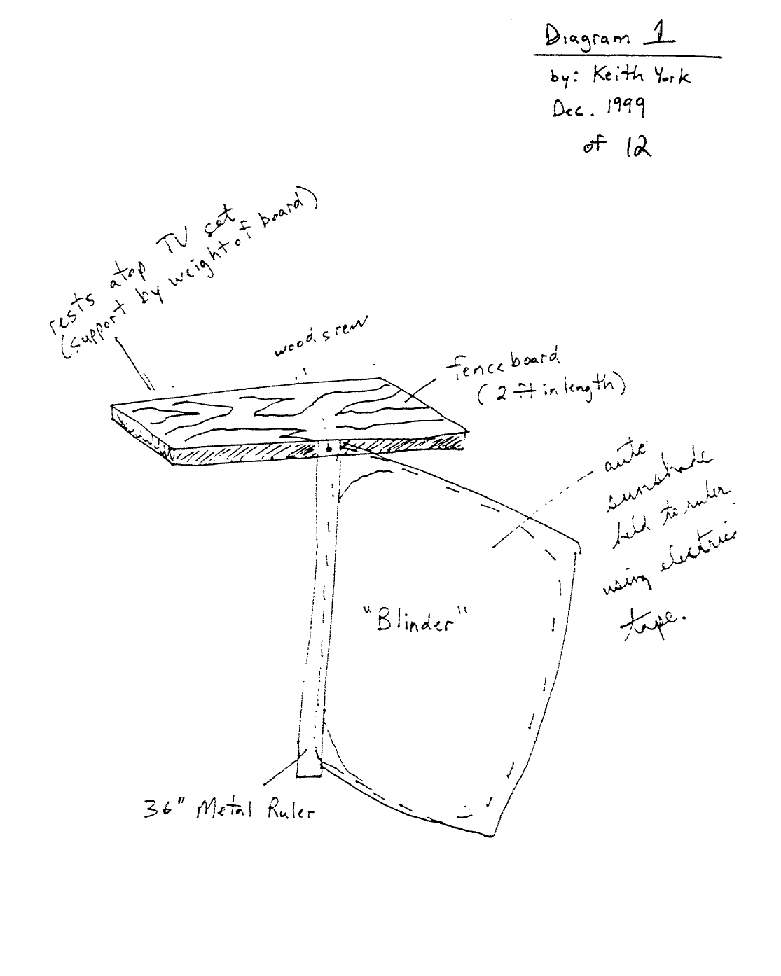

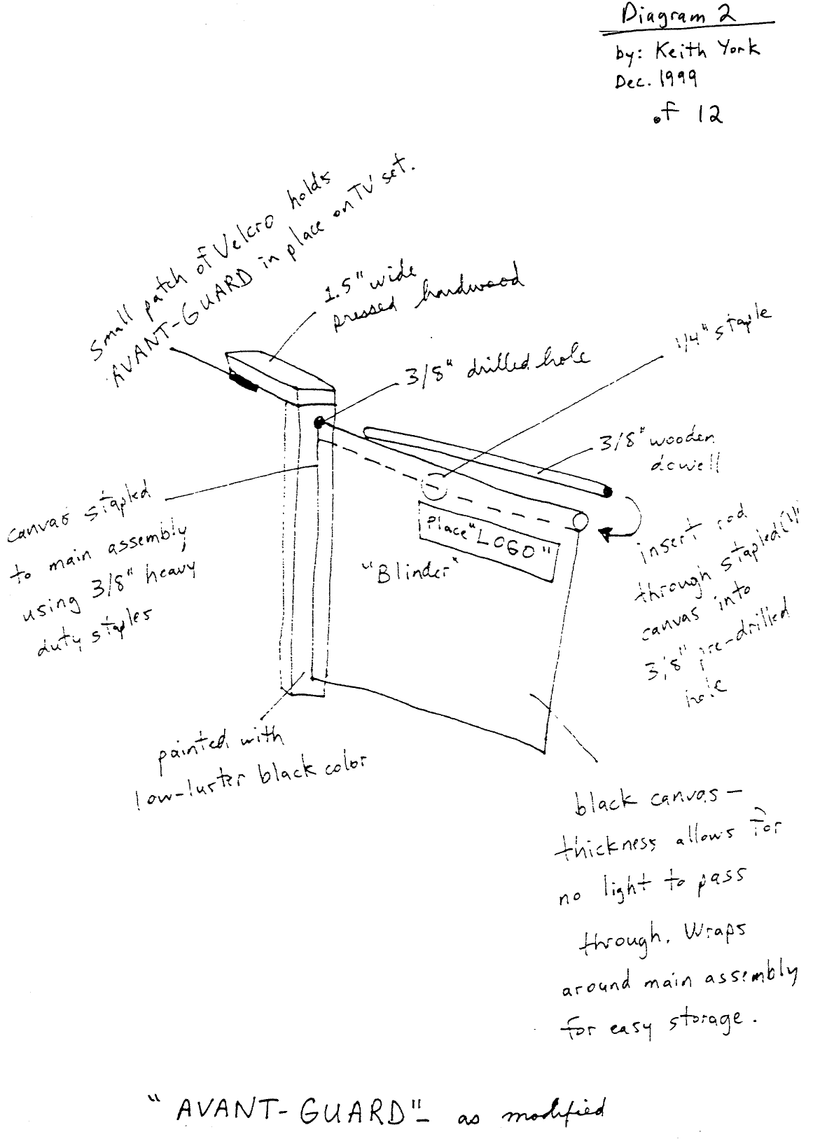

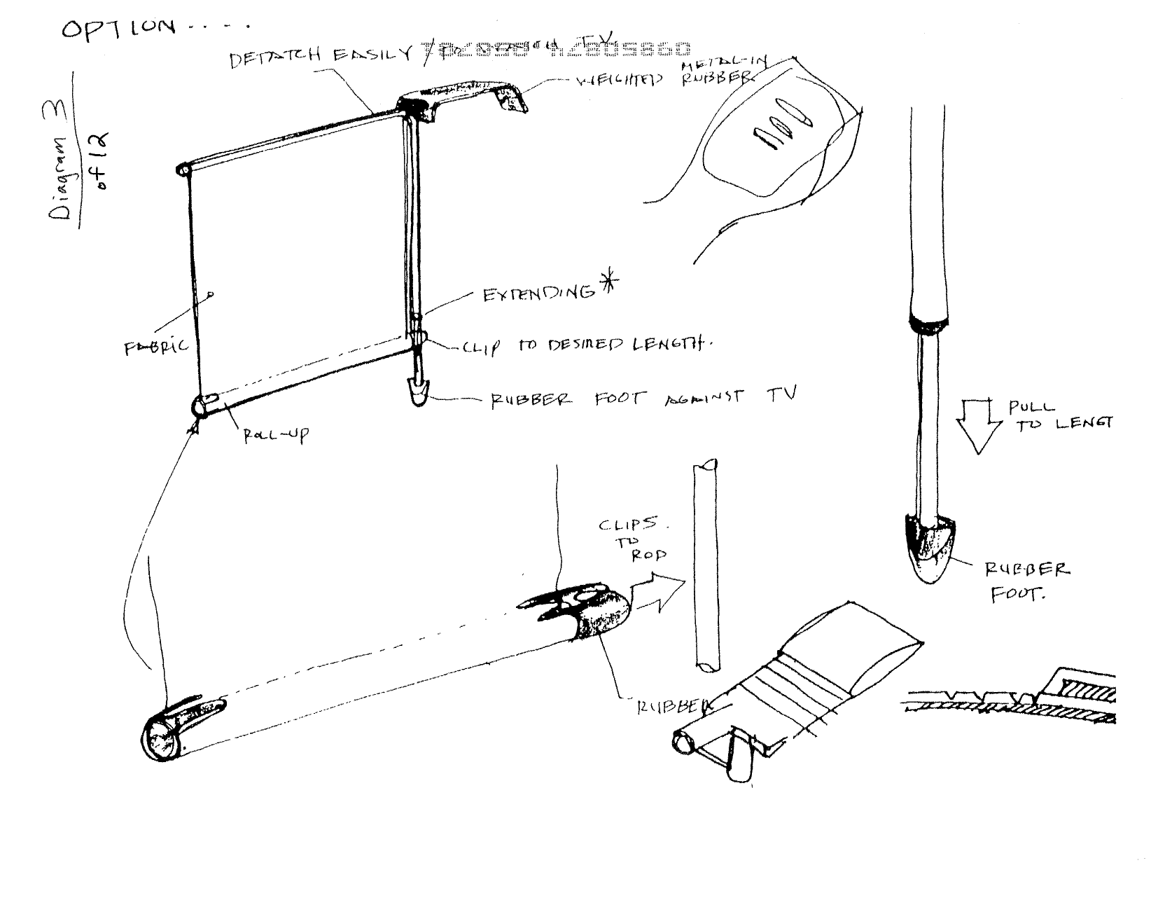

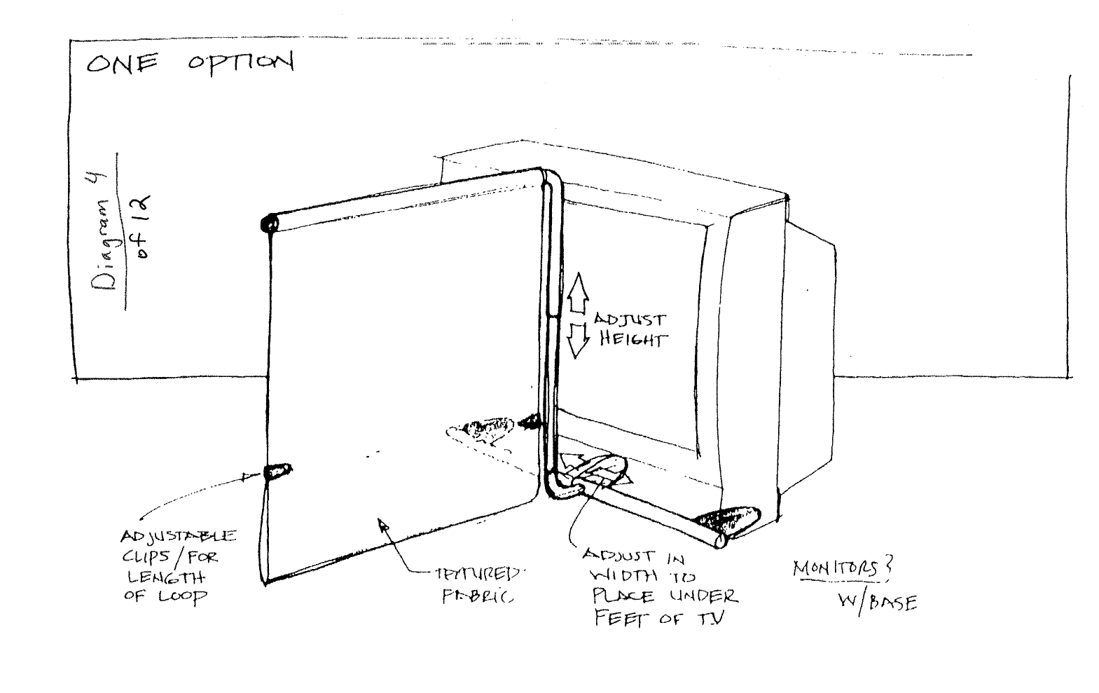

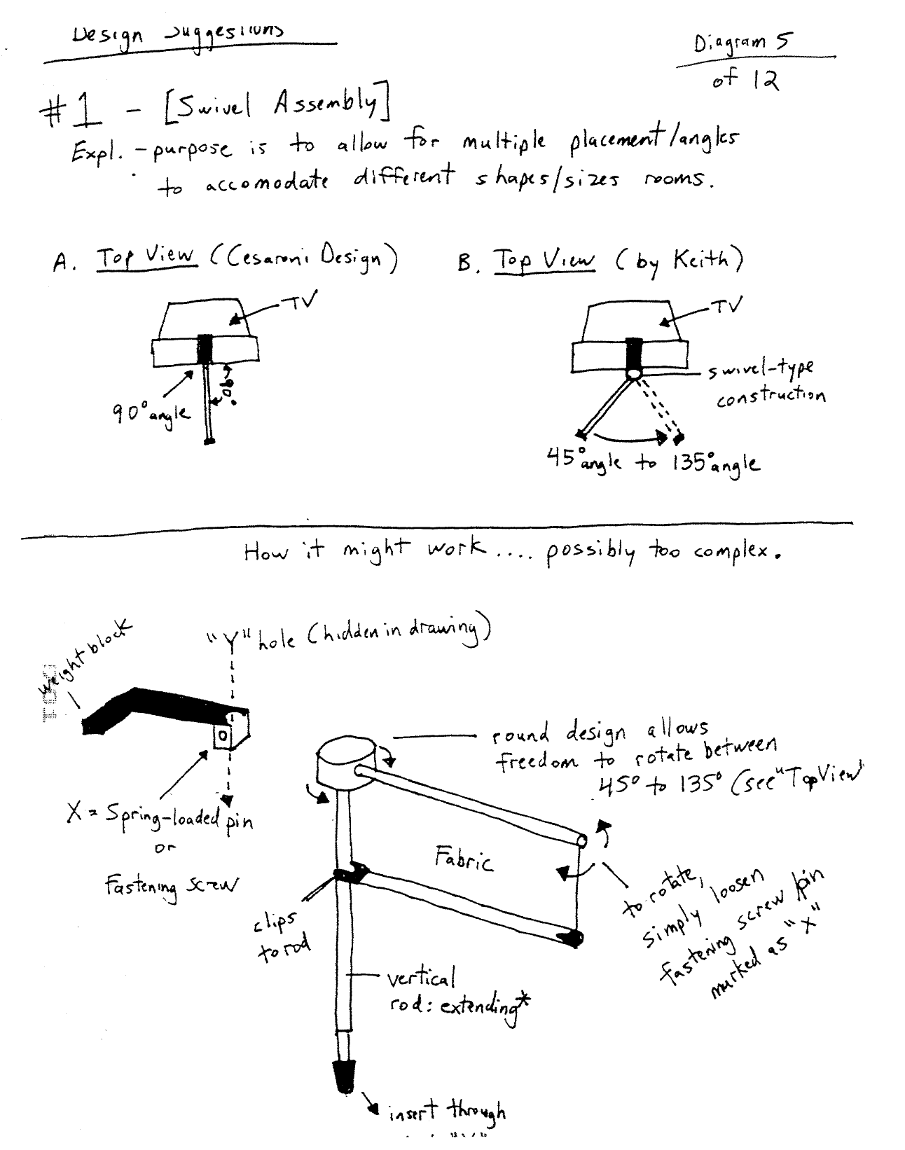

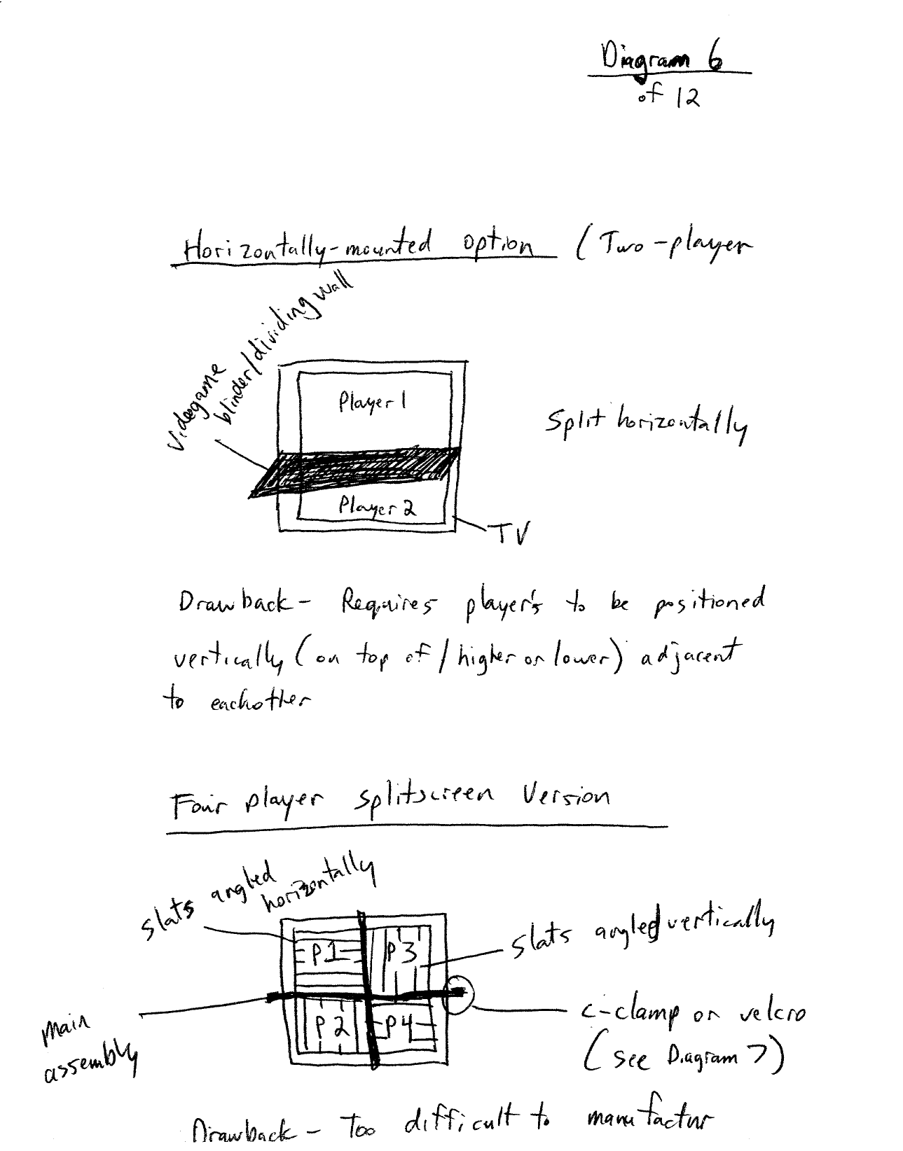

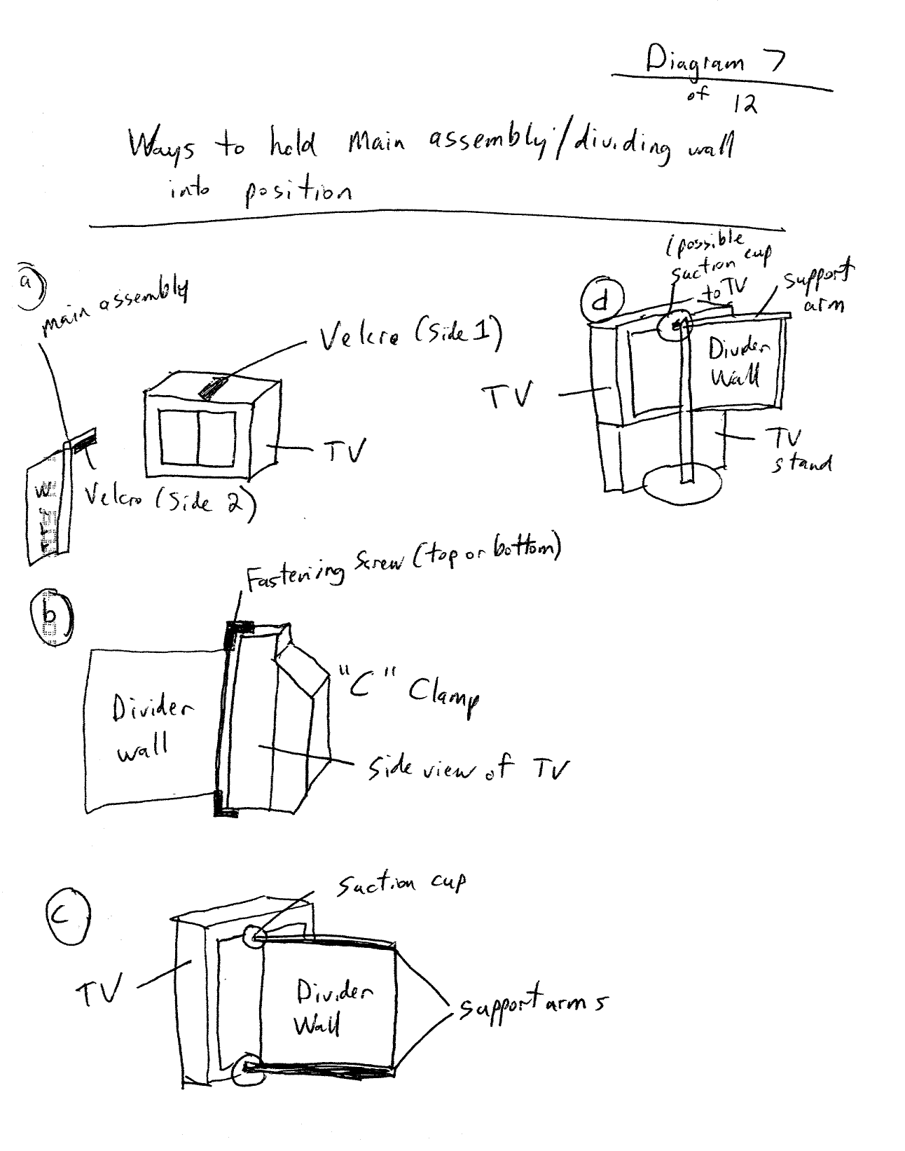

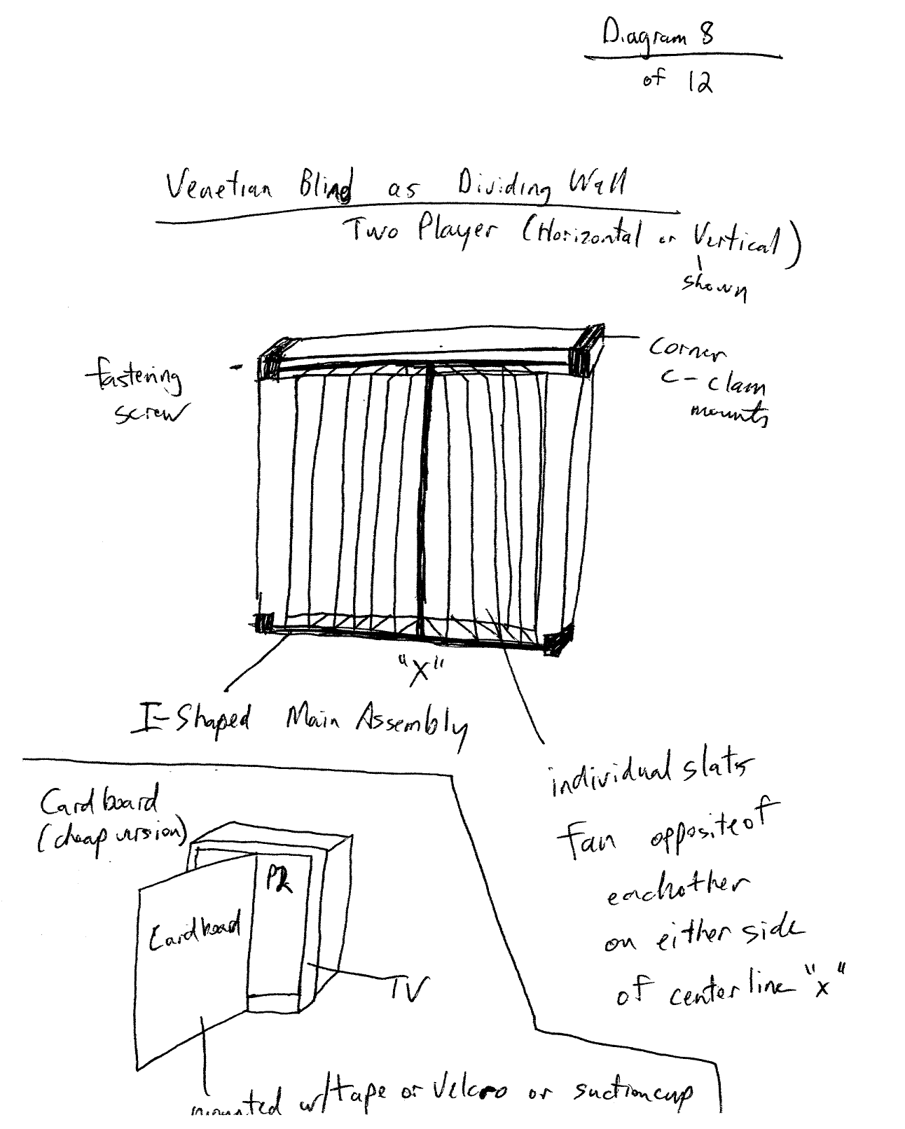

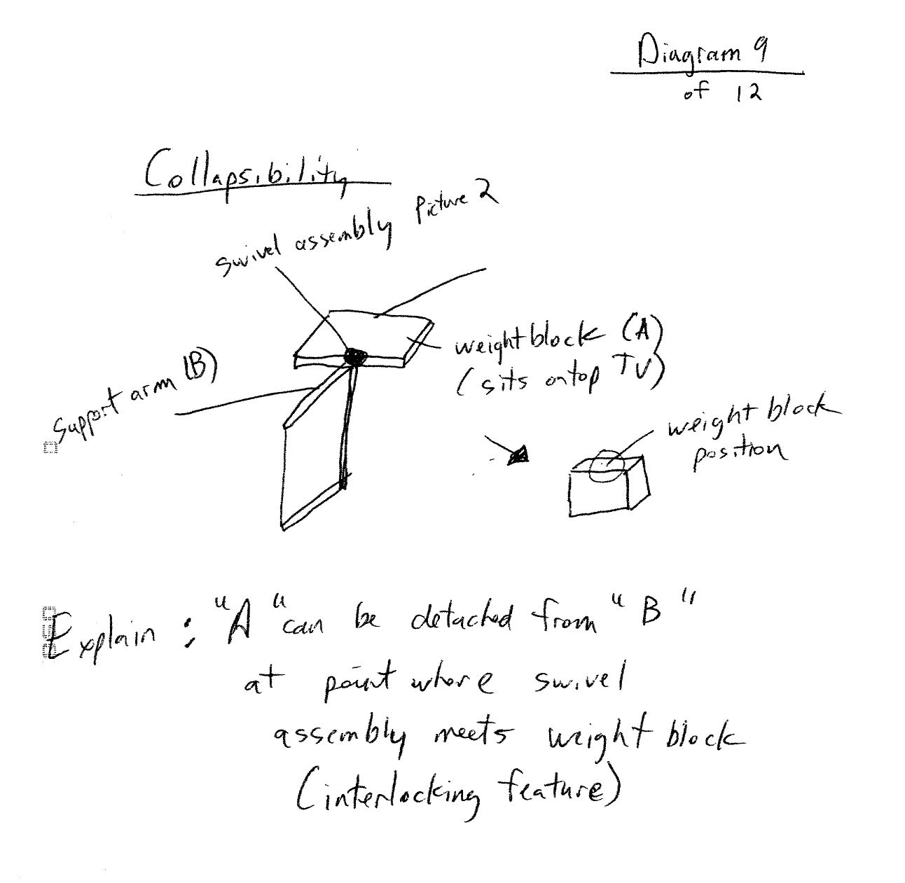

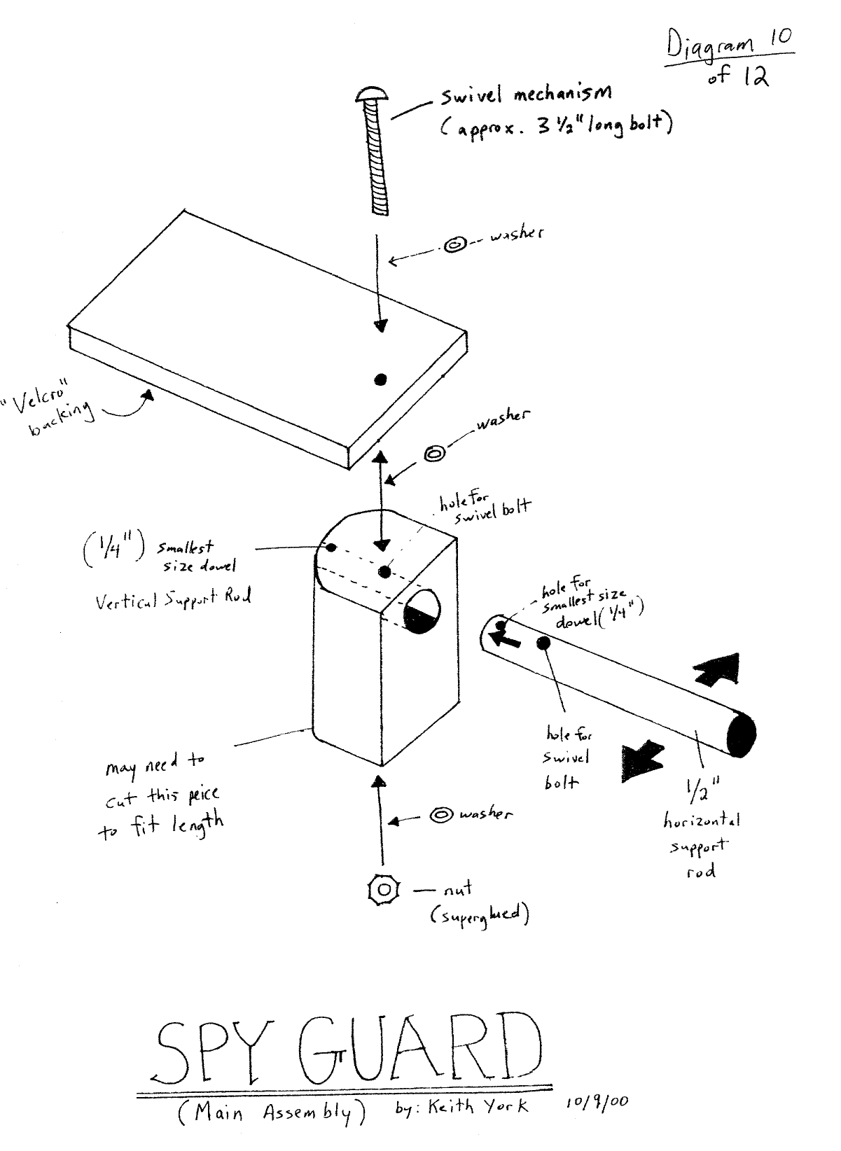

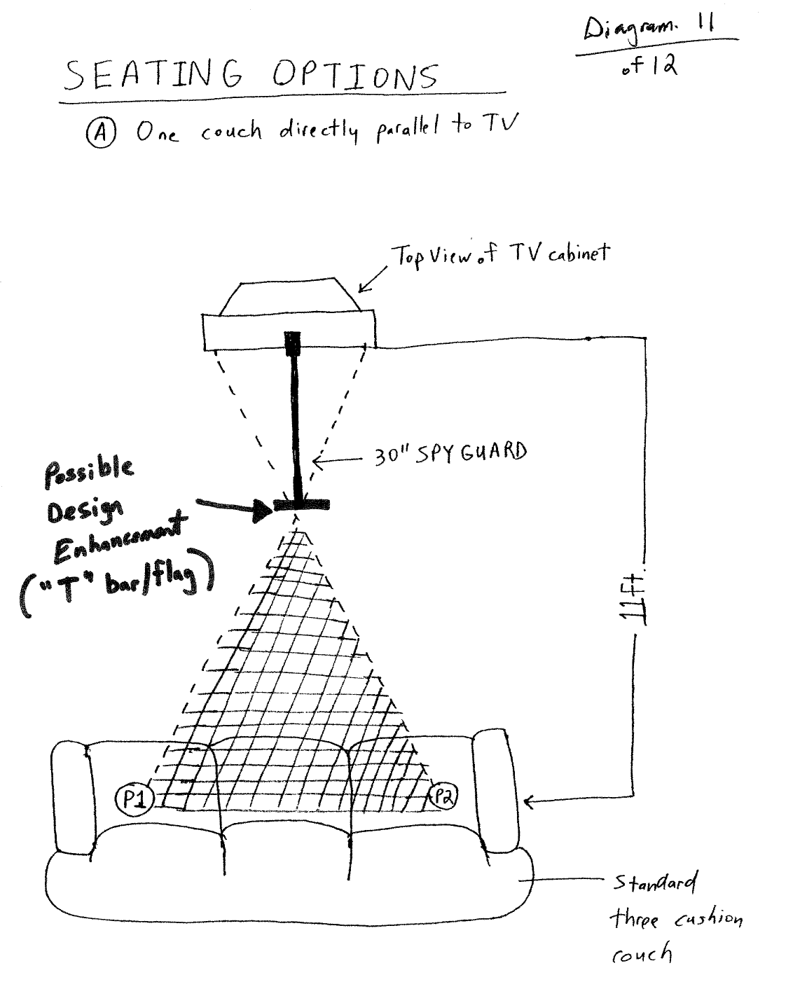

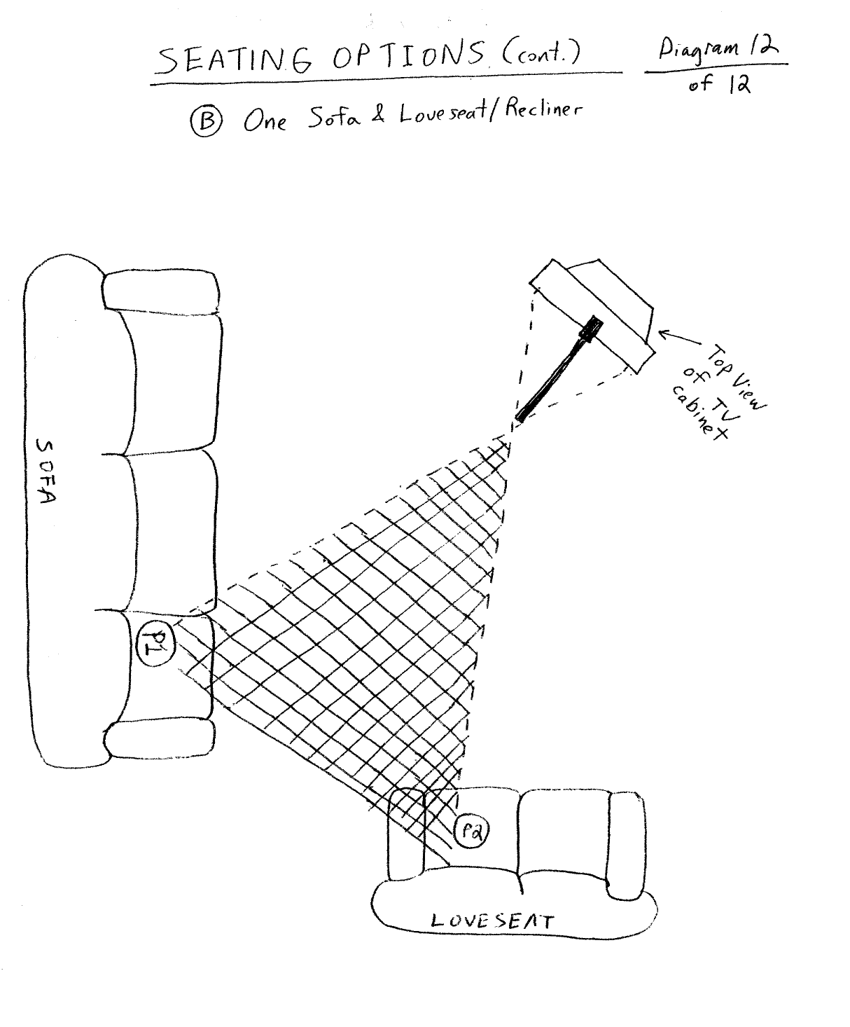

### CROSS-REFERENCE TO RELATED APPLICATIONS

This application corresponds to the PPA 60/202,816 (filed May 8, 2000).

### STATEMENT REGARDING FEDERALLY SPONSORED RESEARCH DEVELOPMENT

Not applicable.

### REFERENCE TO A MICROFICHE APPENDIX

Not applicable.

### BACKGROUND OF THE INVENTION

1. Home Console Video Game Accessories

The present invention relates to an amusement device to be used with a video game machine, and more particularly, an external apparatus that attaches to the television monitor that is used to display the video images produced by the game machine and related video game software. Video game systems are sophisticated computer machines that produce an interactive form of entertainment typically for anywhere between one to four persons. The principal hardware element is an internal central processing unit that the machine uses to process software input devices such as game cartridges, compact discs (CD) and digital video discs (DVD). Using external connections for power supply and audit/video output, the CPU is able to reproduce both audio/video through a television monitor.

Human players interact with the on-screen images by way of an external controller that can be connected either by a cord or using wireless RF technology. Such handheld controller devices are operated via a combination of buttons and directional pads/sticks. See Exhibit 11, an actual instruction booklet from a software title called Perfect Dark for a summary of the basic controller configuration one must use to interact with that software input device.

The video game industry, also referred to as the Electronic Entertainment Industry, is a relatively new industry and has experienced double-digit growth over the last five years. There are three principal segments in this growing industry: hardware, software, and accessories. The accessories segment of the video game industry consists of consumer products such as memory cards, handheld controllers, carrying cases, and various electronic devices including dance pads, steering wheels, flight-simulator joysticks, light guns, and fishing rod controllers.

In the software segment of the video game industry there are many genres of video game software suitable for a wide range of interests. Typical categories for video game software include action/adventure, racing, children's entertainment, puzzle, shooter, role-playing, and sports. The aforementioned Perfect Dark is classified as first-person shooter (FPS) because the principle objective in that game is strategic combat warfare. My product is an accessory that enhances the overall value of that game, as well as any FPS video game that has a multiplayer component.

First-person shooters (hereinafter referred to as “FPS”) describe a certain type of video game wherein the images portrayed on your television monitor are in three dimensions (hereinafter referred to as “3D”). 3D is synonymous with virtual-reality, since images are portrayed on your television screen virtually the same as they appear in real life (the closer an object is in relation to your video game character, the larger it appears). The principal objective in a FPS video game is to destroy your enemy using any means necessary. Players compete in “death match” contests where the battlegrounds are richly detailed virtual-reality worlds where arsenals of military and or futuristic weapons are used to simulate real-world combat. Essentially, these games are a grown-up version of the childhood game of “tag,” except rather than playing “hide-and-seek”, you play “hunt-and-destroy.”

2. Emerging Technology in Console Video Games Market.

Multiplayer FPS games originated in the PC gaming sector where contestants could compete against one another using an online gaming network via a computer modem. Due to the immense popularity of the FPS games, combined with technological improvements in the hardware sector of the console video game market, software publishers subsequently began “porting” (a programming change) computer FPS games to the home console format.

Back when this transition from PC-to-console formatting began, console hardware systems were not Internet compatible. This limitation presented a major problem that was quickly recognized in the industry (see Discussion of Related Art section below). PC death matching over the Internet is the preferred way to play FPS games because you have your own monitor to yourself Having an entire monitor to yourself means that no one is able to see your location, thereby allowing you to roam freely in the VR worlds where your deathwatch battles take place. Such privacy allows one to employ a variety of combat strategies, particularly “camping.” Camping is one of the staple tactics used by any seasoned death matcher. It involves the act of staying in one place that is well guarded from a surprise attack (i.e. inside a room with a closed door). When your opponent comes walking in unsuspected, you have that person in your line of sight and can easily score a “frag.” Moving from one camping site to another helps keep your opponent thinking and on the defensive.

Since the option to play over the Internet was unavailable, software programmers had to engineer a split screen format in order to allow more than two players to compete head-to-head in a console FPS deathwatch contest. Depending on the number of players competing, each of the contestants will have their own three-dimensional display portrayed on a same television monitor using the split screen format. Each player's split screen display would be equal in size, inversely proportionate to the number of players. Between two to four independent displays would be reproduced at either one-half or one-quarter the size of a full-screen display (see Picture 3 for an example of a two-player split screen format),

The split screen format was revolutionary at the time since it allowed console garners a brand-new form of entertainment that was more immersive than games of the past. One of the first FPS video games introduced into the console software market was GoldenEye 007, 1998 winner of the coveted “Game of the Year” award by the Academy of Interactive Arts and Sciences. It is a game that has sold over three million copies in America and is regarded the grandfather of all home console based FPS.

3. Hide-and-seek in a Glass House is No Fun!

Ultimately, people soon realized the limitations of the split screen format when competing in “hunt-and-destroy” FPS video games. The problem was that you had a visual of your opponent at all times. Anyone that has played hide-and-seek knows that the sheer fun in the game is the suspense of hiding and the feeling of surprise after having just been discovered or “tagged-out”. Since FPS games essentially requires the same mentality as playing hide-n-seek, the inability to hide from your opponent changes the way FPS games are played on console systems.

While millions of console-based FPS game players continue to purchase and enjoy FPS style video games, I wonder whether they have learned to enjoy the kill over the hunt based on the limited variations in game strategy. Based on the current manner of game play, if one knows the blueprint of the confined virtual reality environments where the competition takes place, a combatant can easily recognize their opponent's location relative to their on-screen images. Thus, there is no chase or hunting of your opponent—instead your primary objective to kill him/her more times than he/she kills you first.

Using the childhood game of hide-n-seek as a reference, how fun is a game of tag where your opponent already knows your location? Well, if you are able to see your opponent's individual on-screen display, the answer is that there is no fun in a childhood sense. Rather than merely run up and touch your opponent, you are required to kill or “frag” your opponent to score a point in your favor. Because you can't hunt something that can't hide from you, there is a tendency for people to get bored of the same old feelings when playing these types of games.

The problem of the split screen format FPS games has been well recognized in the industry. In the “Official Collector's Edition- Perfect Dark” strategy guide by Versus Books, published by Empire 21 (see excerpts at Exhibit 5), the problem of watching other players screens was categorized as an advanced multiplayer combat tactic. The comment on page 107 reads:

“Ahh, you almost knew we would throw this in here somewhere, didn't ya? Watching other player's screens isn't something you should be doing ALL the time, but it doesn't hurt to check and see what they're up to every once in a while. You can pretty much count on the fact that they'll be doing it to you, so do yourself a favor and use this tactic without remorse!”

While this comment implies that one can gain a competitive advantage, it doesn't truly emphasize the extent that the game play suffers because of this tactic. However, in the December 2000 issue of GameFan magazine, this point is better clarified in the review of the PC-to-console port of Unreal Tournament (UT) for the Playstation2 video game system. The relevant comment reads:

“Speaking of which, UT was always designed a multiplayer frenzy and the PS2 does offer up to 4-player action. This is your standard split screen though, and the game play suffers because of it. FPSs are like RTSs (note: real-time strategy games): YOU NEED YOUR OWN SCREEN FOR IT TO WORK PROPERLY (emphasis added).”

### SUMMARY OF THE INVENTION

1. Makes Playing Multiplayer Video Games More Fun and More Realistic.

My invention consists of a means of erecting a dividing wall on the front face of a television screen. This is a method of partitioning the dual-set of images displayed when playing multiplayer videogame formats, such as head-to-head “deathwatch” battles. My invention restricts a certain form of competitive cheating by preventing either opponent's from viewing the private screens of their challenger. In summary, my invention provides an effective solution to the “wandering-eyes” gaming technique (see Executive Summary at Exhibit 9). The dividing wall extends a sufficient length perpendicular to the face of the television screen such that it provides an adequate measure of privacy, adaptable for normal seating positions.

The main aspect of my invention is its ability to offer privacy to video game players that share the same television monitor when competing against one another. In its most preferable form, it is compatible with any multiplayer video game (see Picture 4) that utilizes a vertical split screen format where two individual images are separate by a dividing line running down the center of the television monitor. A separate type of apparatus would be necessary to produce the same effect for games using a horizontal split screen format (as seen in Picture 3). However, such a device would not be as efficient or as convenient for the game players. For one, attaching it to one's television would necessarily require a clamping assembly or similarly, affixed to the television using Velcro of suction cups. My design incorporates the force of gravity, making it very convenient for quick set up and removal.

Below is a list of patent classes that may include video game accessory products. I believe my product would likely fall into one of the following:

Class 273 —Amusement Device: Games.

Subclass 446 —Amusement Device: Toys.

Subclass 148 —Control Device for Game Machine (force-feedback/vibrating controller)

2. Description of Related Art¹. As far as I have been able to discover, no similar product has been offered for sale nor does it appear that a patent application has been filed or granted on a device similar to mine.

Other consumer products already exist in the marketplace that address the privacy problem that my product solves (i.e., the link cable and online gaming). However, these two products are distinguishable from my product because they rely on technology where my product does not. I feel my product is unique and deserving of a patent because it provides a cost-minded alternative to either of these two related products, yet provides nearly the exact same or better experience (due to improved social interactivity). Because of the simplicity of this product, it can be manufactured at a low cost and brought to market to retail at a small fraction of what these alternative devices/methods cost—hence a super value to the end user.

Since privacy is fundamental in a game of “hunt-and-destroy,” a new product was introduced to market that enabled console systems to be linked-up to one another and used to simulate an online gaming network. “Link cables” are sophisticated data relay devices that enable the CPU in one machine to communicate with the CPU in the other “linked-up” machine. This allows video image data to be fed back-and-forth relative to each of the video game player's movement relative to one another. In essence, the link cable disabled the programming that was used to provide a split screen display onto a single monitor using a single audio/video output.

Console hardware machines have limited processing power. When a split screen format is used, the same amount of data processing power must be shared equally between each of the split screen displays. Put another way, the quality of a split screen display when playing a four-player game is ¼^{th} the quality of the full-screen display that a single player would see on the same television monitor if playing by him or herself.

By combining the data processing power of multiple CPUs (currently technology allows up to eight console systems to be linked together), the link cable allows each death match combatant to appear on their opponent's television video display, and vice versa. This shared input produces the same results as split screen death matches on a single television monitor, except with higher quality graphics and more importantly, privacy of one's screen.

The link cable was and still is viewed as a ideal solution to the privacy problem for console FPS death match games that are not Internet compatible. But, it is also a product that serves a very small segment of the gaming population—the ultra hard-core or the super-affluent—this product requires at minimum, two video game systems, two televisions, and two of the same video game software titles to be hooked-up within a predetermined length from each other (the standard link cable is only 6ft long).

I don't believe that the majority of video game consumers normally would have two televisions, two console hardware systems, and two identical pieces of software. Thus, if a console gamers really wished to experience the thrills and suspense of death match battles online as PC gamers, he or she would need to haul their extra equipment (TV, video game system, software) over to a buddy's house. Or, he/she would need to purchase the extra equipment on their own and hope your friends want to come over to play. For economic reasons, the concept of the link cable does not offer a mass-market solution to the privacy problem.

Since the link cable is not for the majority of video game consumers, industry leaders have began development of online gaming networks for console systems. Online gaming offers the same experience as the Link Cable, except that it doesn't require your opponent to be in the same room as you (i.e. each of you can compete from the comforts of your own living room). The first such network is SegaNet, a video game Internet Service Provider (ISPs) and like other ISPs, there is a monthly fee of roughly $20/month for service. However, if one already has an Internet connection, that person can also dial-up using a non-SegaNet account (i.e. AOL, Earthlink, Prodigy). While the cost of online service via your ISP is seemingly less than what it might cost to create a Link Cable setup with multiple TVs, game systems and software, it too is not a solution for everyone.

One of the essential requirements of online game play is the ability to transfer data at high-speeds. A high-speed connection of 56K is necessary to transmit the substantial amount of data that are necessary for a quality video gaming experience. The speed of one's Internet connection is measured by “pings.” A ping is the amount of time it takes one packet of data to be sent from a gamer's machine, to an online server he or she is playing on, and back. This time contributes to the player's “lag.” The higher the ping count, the greater the lag, or latency. The lower the ping count, the faster the game play.

Unfortunately, Sega is the only video game company that currently has Internet compatible games and its console system, named the Dreamcast, has a built-in 56K narrowband modem. In many of the current online games, the problem of latency is so bad that it renders online game play virtually pointless. For instance, in NBA 2K1 (an online basketball game) that I personally own and have tested numerous times online, the lag is so bad that I must press and release my jump shot in advance of when my player is actually performing a jump shot on my video display. If I was to release the button (timing your shot is essential for accuracy) at the time when my player was at the highest point of his jump shot (the ideal time in video game as well as real life basketball), I would be called for traveling if playing online. That is because the amount of time the data packets are transferred from my game machine to the online server and back is greater than the amount of time it takes to come down from a jump shot (in basketball, if you jump and land back on the ground while maintaining possession of the ball, you will be called for a traveling violation and will be forced to turnover the ball to your opposing team).

Currently, the other major hardware companies (Nintendo, Sony, Microsoft) have yet to announce official plans regarding when and will they be introducing online compatible games. This is because of the limitation of 56Kbps modem technology. 56K is considered narrowband, referring to the small amounts of data (measured in bytes per second, hence a maximum of 56,000 pieces of data that can be transmitted during a one second interval). The future lies in broadband network technology; where up to 10Mbps (10 million) of information can be transferred in the same amount of time. In the future of broadband, lag may no longer be an issue for the majority of online users, including video game players.

3. Solutions for Today and Tomorrow.

So, while the solution of online gaming using broadband technology is a better option that looks to become a reality, it is also not predicted that this change will take place for a minimum of 2-5 years. This is the time when industry experts predict that the price of broadband service (i.e. digital subscriber lines or DSL) will reach mass-market affordability. Currently, DSL service costs an average of $49.99 per month. Thus, even if broadband modems were available for online game play, one would need to pay roughly $30 extra dollars per month to upgrade from standard 56K to high-speed DSL or cable service.

Broadband offers a solution to current problem created by having latency during game play when using a narrowband modem (anything that affects your timing when playing video games impacts your ability to be competitive). Another advantage of broadband is its ability to support other products designed to enhance the social interaction between online game players. Many new online video game accessory products are currently in development, such as voice-relay units and web cameras, designed for broadband gaming on console systems. These types of products do not currently exist in the marketplace because their use requires more data to be shared on a network line that is already being used beyond full capacity. Thus, a catch-22 situation exists in that the more you try to fit down the pipe, the slower the game play. Slowdowns in game play, also know at latency or “lag,” creates a major source of frustration for online gamers—lack of “real-time” response to their game controls. Until broadband network connections reach mass-market affordability, social interactivity via Internet peripheral devices will likely be of little interest in the consumer marketplace.

A comment from Joe Fielder, Editor-in-chief at Gamespot.com, one of the largest online websites dedicated to video games should help clarify this better (see Exhibit 8). His remarks on why playing online over the Internet is not as fun as playing on a local-area network (LAN) were as follows (see page 2, dated Apr. 7, 2000):

“Playing games online is actually very fun, though more over a LAN connection where you have other people in the room than against faceless opponents scattered throughout the U.S. Even still though, it's really fantastic to be able to have a full screen to yourself and to know that no one else is looking where you are at.”

A LAN network connection is different from a WAN, or wide-area network, because LANs are used to connect computers in an office setting whereas a WAN is used to connect users from across the globe (i.e. the link cables are LAN, except instead of PCs, console systems are networked locally). Joe's comments revolved around the fact that with LAN-based death match, you can at least hear the reactions from your opponents since they are sitting in the same office suite as you. On the Internet, players are competing against unknown people and so the experience is less intimate and therefore, less enjoyable.

4. Objects and Advantages

In this section, I will explain what this invention accomplishes over prior art and why this product offers unique advantages to become worthy of patentability. In sum, this invention offers a cost-minded alternative to online gaming for home-console video game players. It produces the same level of intense competition as online gamers (both PC and on SegaNet console system) and offers a better overall experience because of the ability to interact with your friends/family in the same room. It does every thing that the Link Cable and online gaming seek to accomplish, at the minor expense of having to view a smaller screen with less graphical detail. Once you and your friends experience the thrill of competing using realistic strategies and experience first-hand, the satisfaction of winning now that you can compete on an even playing field, you will forget that you are only playing on a small screen. And you don't even have to sit any closer to the television than normal.

Privacy is the single greatest advantage online multiplayer FPS death match garners have over their split screen counterparts. Social interactivity is the single greatest advantage console garners have over their PC brethren. The product I've invented combines the best of both worlds at only a fraction the cost of one unit of video game software (its MSRP will likely be in the range of $10-$20; the average price of a video game is $40-$50). It will breathe new life into your old games because it creates a new way to interact with your friends on a more competitive level. Any game, whether new or old, regardless of what video game hardware/software you own, will benefit from unlimited game play since no two games are ever the same.

Another benefit that should not be overlooked is that this product is compatible with ANY video game that utilizes a vertical split screen format for head-to-head action. Many genres of video games, particularly racing and other extreme sports (i.e. snowboarding, skateboarding, BMX, etc.) use the vertical split screen due to the amount of vertical game play. For instance, in the Tony Hawk Pro Skater series, there is a two-player mode where you compete against your opponent in a game of tricks. The more tricks you successfully land, the higher your points. The person with the highest amount of points wins.

With this apparatus in place, your view of your opponent's screen is blocked from your line of sight. Since there is no need to see your opponent's screen, nor he/she yours, you can instead hang the blinder assembly in front of your television monitor and block the distraction of having another persons images blurring your view. This allows you to concentrate more on your screen and allows you to have better timing. Plus, there is less eye fatigue and dizziness since you are not being bombarded with a constant set of images that your mind does not know how to process (since the images are unrelated to your ability to compete).

In racing games, being able to see your opponent's screen allows you to anticipate when they are attempting to pass. Normally, you would be required to use your in-game rear view mirror to keep a watchful eye out for your opponent. However, you would be wise to simply look at your opponent's screen since it represents a clearer picture of what he/she sees if you are in the lead in the race. If he/she attempts a pass, you will notice your car appear very large on your opponent's screen, meaning he/she is literally on your tail. This affects realistic driving strategy in that, if you are the person trying to pass, you won't be allowed to sneak by your opponent if that person is good enough to cheat. He/she would merely need to slam their brakes and stop your momentum or simply cut off every inside comer and force you to pass on the outside (a difficult move if you don't have a more powerful car, momentum, and especially in a tight comer).

Privacy of one's screen makes for a more competitive challenge for all levels of gamers and is more immersive due to the suspense and the element of surprise, no matter what type of game is being played. However, for multiplayer FPS death match contests, privacy is more of a necessity than a convenience. When playing with a group of three friends in a four-player split screen, two-on-two team death match mode (see Picture 6), each two-person team has the ability to view their respective teammates images to coordinate combat tactics, all under complete privacy from the opposing team. Being able to view your teammate's screen enables a more realistic perspective when attempting to hunt in tandem.

5. Testimonials from Personal Friends/industry Professionals.

Every single person that I've shown this concept to understands the value and purpose of this apparatus. This includes industry experts, including: Shane Satterfield and Joe Fielder—professional video games Reviews Editors; Russell Braun, VP Sales/Marketing—InterAct Accessories; Dan Kramer, Director of Product Development—Nuby Interactive; Howard Borenstein, Chief Operating Officer—NYKO Technologies; Collin Anderson, President—Digital Innovations; Marshall Crawford, President—Divisionl Accessories; Mike McDermott, Brian Furtado, Kyle Anchetta, David Isaac, Bob and Tanner Muckey, Greg Valles, Seren Taylor, Paul Brainin, Core-gamers ranging in age from 10 to 43 years old.

This is product worthy of a patent because it has the potential to make the video game industry get even bigger. It will create new sales of software because people will want to experience every multiplayer FPS death match to explore new and different worlds, use different weapons, and find new ways to compete against your friends/family. The concept of “hide-and-seek” type video games is even evolving into the childhood markets, where companies are using the same technology to make FPS games, but instead of guns they substitute water balloons, fruit, etc. that one can throw at their opponent rather than shoot them for dead.

Considering the fact that there hasn't been anything so revolutionary as force-feedback technology, I see this product as an invention that will be well received by video game consumers and industry critics alike. To quote from Chapter 7 in the 2000 Industry White Paper (produced by IDG Games Media Group, publishers of GamePro Magazine with over 3 million monthly subscribers) entitled “Unmoving Front—Peripherals Outlook”—see Exhibit 1:

“I'd love to see specific controllers that have functionality geared towards specific games.”—Darren Richardson, President and Chief Operating Officer, MadCatz Accessories;

“For us, the philosophy of peripherals is that they have to enhance the gaming experience.”—Peter Moore, President and Chief Operating Officer, Sega of America Dreamcast, Inc.;

“We'll have a camera so that if I am gaming against you, and you're in San Francisco and I'm in New York, I can see you on the screen—that's the core of being able to trash-talk. I've seen this demoed, and it adds a lot of realism when you can actually see your opponent on the screen.”—Peter Moore on enhancing the social interactivity when playing video games over the Internet;

“I have yet to see something interesting other than variations on the game paddle. I really like the idea of Rumble Paks and force-feedback, tension control, and things like that, because they evolve the basic game paddle. But, what would be nice to see is some sort of new device. I don't know what it is, but it should do for consoles what the mouse did for PCs, which is to literally change the way we think of that device, and how much we interface with it.”—Lou Castle, Executive Vice President, Westwood Studios;

“Whatever new peripherals are brought to market, developers need to keep their audience in mind. I think one thing that even our company has made a mistake at is understanding how important gamers are to the market. Gamers are such prolific buyers. They buy more software than anybody else, and they buy hardware. They're willing to buy hardware if they think it will help their performance in games.”—Ed Fries, General Manager, Entertainment Business Unit, Microsoft Corporation.

The apparatus I've invented (see Exhibit 2 for a digital concept rendering by an award-winning industrial design firm based in Chicago) is the answer to each of the above bulleted concerns. It changes the level of immersion a console video game player experiences by enabling the use of strategy, creating a heightened level of suspense, and making game players more competitive. Additionally, this invention may have a positive impact on the perception of violent video games by the media because of how it changes the focus of how these games are played. This invention causes a paradigm shift in the game player's attitude from a morbid, isolated mentality to a more creative, more social experience. This point is echoed in the 2000 Industry White Paper—Chapter 1 entitled “As the Dust Settles—Industry Performance 1999” (see Exhibit 3):

“I don't know that the PC will ever be a great gaming platform given that consoles are more social. The PC is solitary. To truly create a great gaming environment, it needs to be social. The PC is not ever going to be the central entertainment portal of families.”—Chris Mike, Vice President, Marketing—Konami of America, Inc. (software publishing giant).

6. Paradigm Shift Opens Up a New Realm of Social Interaction For All Age Groups.

The paradigm shift I am predicting relates to the gruesome nature of the games my product is primarily designed to be used with—namely multiplayer first-person shooter (FPS) death matches. Multiplayer death match games originated in the PC gaming sector and established a tremendous fan-base in a relatively short amount of time. However, the game players are limited to playing alone as PCs do not utilize a split screen format. Instead, one needs only to log on to the Internet and compete against other death match garners in cyberspace. Because of the solitary environment, I believe that there may be some long-term psychological effects on the people playing death match games over the Internet.

A study conducted by the Interactive Digital Software Association (IDSA), sponsors of the Electronic Entertainment Expo—the industry's largest trade convention held each year in Los Angeles, Calif., indicates that the vast majority of people who play do so with friends and family (see Exhibit 7, “Ten Facts About the Computer and Video Game Industry”—item #4). In the 2000 Industry White Paper by IDG Games Media Group, cover entitled “The Battle for the Family Room,” social interactivity is considered the single greatest advantage console garners have over their PC gamer counterparts.

The ability to interact adds to the overall experience and fin, particularly when your opponent's have a tendency to talk-trash to you when they are winning. To compensate for the lack of social interaction when playing online, the keyboard controller was introduced, allowing players to chat back and forth during online game play. Though this does add a new dimension to the game, one quickly realizes that there is little creativity or desire to engage in long-drawn conversations because it is difficult to communicate via a keyboard and control your computer character at the same time (unless you have an extra pair of hands).

Network gaming is an exciting form of game play, especially when playing multiplayer death match contests, since the challenge is greater than when playing on a split screen. However, only one player can play at any given time. As such, players will have to take turns in the event one is even willing to wait the long duration of time that it takes to finish one death match contest. When I play Unreal Tournament, a FPS game designed specifically for online play using SegaNet, the normal set-up is to have the winner decided by the most frags in a 10 minute time span, or the first to score 30 frags, whichever is sooner. When my friends come over to my house, they all want to play and hate to have to wait—this invention allows up to four people to experience more interactive entertainment than they've ever known the world of console video games—I am sure of it.

Another aspect/disadvantage of subscribing to an ISP for online game play is that, if all you are looking for is a tough challenge, you can get all the challenge you need from the computer. Modem technology has allowed software programmers to improve games beyond graphics and sound. One particular area that deserves much recognition is the level of artificial intelligence (AI) built into today's video games. If you wish to compete in a death match and you don't have any friends that are able to come over, nor if you have online capabilities, you can choose to compete against A.I. computer robots. Industry critics have commented that the A.I. “bots” are sometimes more fun to play against than humans online because they have been taught better strategy and are more formidable opponents than many of the people you wage war against online.

While the action of hunting other human opponents in cyberspace is fun, you aren't allowed to compete against someone in the same room as you. If you wish to play against a friend, this would still require that each of you own the same machine, have the same game, and both be subscribers to an Internet Service Provider. Plus, you can't control who joins in the fray since this is all done through a central server. Another point to note is that you must also be able to find a suitable form of identification when going online so that you can actually identify your friend in one of the gaming lobbies where users may join into an online “frag-fest.”

Of all of my close and personal friends, only one of them owns a Sega Dreamcast but doesn't own Unreal Tournament as I do. Therefore, until he purchases that game, I am limited to playing against unknown people whose only method of communicating with me is through a keyboard interface—not quite the same as having someone right at your side to share the intense feelings that result in a death match competition. If I play, I like to play against people I know because I can talk trash to them time and time again, developing a nasty rivalry that will keep them coming back for more.

Another advantage of the apparatus I've invented is that it curbs the suffering felt by novice console video game players, people who never get a chance to learn how to compete because they are too busy getting destroyed by their opponents. Let me tell you from personal experience, I refuse to play any game where I do not have a realistic chance of winning. As an expert game player and a person that has been playing video games for over 15 years, developing a mastering of the game controller is the first step towards becoming more competitive. But doing so requires ample time to learn and practice and my learning curve is elongated when I don't have adequate time to avoid being attacked by an opponent that knows my every move. Thus, whether or not I am proficient with my controller, I am still at an unfair advantage against a veteran player.

7. Levels the Playing Field for Novice Gamers Means More Willingness to Play.

Challenging game play in a social environment is what the Interactive Electronic Entertainment Industry is all about. Yet on a split screen format, the only way to remain competitive and to offer any challenge to your opponent, you must keep moving target. The reason is elementary, a moving target is harder to hit than a stationary one. As a result of this game strategy, console-game experts had to quickly learn such tactics as “circle-strafing.” Circle strafing is a core combat maneuver where the death matcher will circle around his/her opponent, continually firing in their opponent's direction. Industry experts commonly refer to this manner of game play as “run-and-gun,” and summarily criticize it for being one-dimensional and tiresomely routine. Being that there is no other way around this (until now), many true death match gamers dismiss split screen death matches as unworthy of their time.

Consider a situation where a complete novice is invited to play a multiplayer death match on a split screen, without the use of my video game enhancement/apparatus. A true novice player will always have a long learning curve because video games no longer utilize simple control schemes like in the days of Pong. Most controllers nowadays have upwards of eight buttons, often used in simultaneous fashion to produce a desired reaction. For instance, the normal operation of the directional joystick in a FPS game is to move your in-game character forward/backward and left/right. To look around (as in the first-person perspective), one must press and hold down a pre-configured button to enable the joystick control to toggle from one's feet to one's head. Done properly, a player can quickly survey his surrounding environment to identify a potential threat from attack from a nearby opponent. Other buttons are required to perform moves such as selecting a new weapon, jumping, opening doors, climbing ladders, and strafing (moving sideways while looking in a forward direction—used to peek around corners).

When playing against a novice with insufficient knowledge or practice learning how to properly aim their weapons using the control one's in-game character, you'll often find that they are in a state of confusion. Video game controllers have evolved into highly complex input devices, requiring sophisticated manipulation/precision timing of the game controller to produce the desired effect. Put into the hands of a novice is like virtual suicide. When playing a death match game against a novice player, when you stop to look at their screen, more often than not you will find that their player is staring at the floor and attempting to walk through a brick wall—to their competition, they are literally a sitting duck. If the extent of the novice's game play experience can get no better than being shot in cold-blood, you can bet that this person will never be playing against you again. With apparatus in place, privacy is enabled and with this comes suspense and strategy. This apparatus changes the way multiplayer FPS games are played, making all levels of combatants more competitive. Novice players who may not be as familiar with the layout of the VR environments can at least buy extra time if they utilize basic common sense. By staying in a well-guarded place, or “camping,” the novice player can anticipate what to expect more accurately since his opponent no longer has the ability to cheat. When an expert doesn't know where his opponent is, you can bet there will adrenaline flowing through both players' veins. As a form of entertainment, video games are played for the sake of the challenge. Winning is rewarding, especially when competing against humans rather than against the computer. This product presents a challenge that has never been known to the vast majority of multiplayer FPS video gamers on console systems.

Another advantage of this invention is that it is compatible with ALL video game hardware machines currently on the market. This is a rare claim in the world of video game accessories, the only two products I can think of that are cross-platform (non-brand specific) are universal power cords and universal RF-adapters (for external connection from video game system to your TV). Video game software, on the other hand is generally compatible with a specific brand of video game hardware or platform. Similarly, most accessory devices are compatible only with one specific brand of hardware machinery.

8. The Most Revolutionary Innovation Since Force-feedback Technology.

The basic philosophy of a peripheral is that it must enhance the overall value of the core product is designed to be used with. Yet, as a market segment, there has been little innovation to speak about other than when “force-feedback” technology was designed into a video game controller. Force-feedback is an example of the modem technological advancements that bring the level of immersion to a greater level, consider U.S. Pat. No. 6,225,975. That device became a mass-market item within the last two years, first introduced by Sony Corporation of America with the brand name of Sony Dual-Shock Analog Controller (see Exhibit 4). The reason why it's called force-feedback is that the game controller had a vibration device inside its main body that would react to the images displayed on the television gaming screen. For instance, when playing shooter games, the controller will vibrate according to the type of weapon being fired (i.e. a machine gun vibrates rapidly; a shotgun blast produces a powerful recoil).

The evolution of modem video games has benefited greatly from technology such as that just described. However, my product is as revolutionary as the Sony Dual-Shock Analog Controller because the effect created will forever change the way the user interacts with their video game machine. A user that experiences the realism associated with force-feedback technology will always choose this option because it offers an improvement over the old controller interface. Similarly, a person that utilizes my device to play their video games will most definitely consider it the only way to play in the future because it satisfies “an increasing demand for a game machine that adds to the realism”—see Description section of U.S. Pat. No. 6,225,975. My multiplayer game enhancer increases suspense, strategy and realism not by way of technology, but by way of simple innovation.

For all of the above reasons, I believe this invention is unique, unobvious and novel in relation to prior art. The value of my invention is that it is more accessible to a wider consumer base because of it does not require any extra equipment to work effectively (as is the case with the link cable and online gaming). Another aspect that is significant and valuable, is that my invention greatly improves the replay value of FPS games that already support the vertically split-screen format. I believe my invention will spark new levels of excitement into the existing videogame market because it will allow the average home video gamer an opportunity to experience the same levels of enjoyment felt by PC-gamers. Also, my invention does not require the individual to subscribe to the Internet to play FPS death matches on-line and for that reason, it would save many consumers an average of $20/month.

### BRIEF DESCRIPTION OF SEVERAL VIEWS OF THE DRAWING

The following diagrams/pictures are being submitted with this application (listed in priority order):

Diagram 1 Original drawing of my invention—12/99

Diagram 2 Modified drawing of my invention—12/99

Diagram 3 Professional rendering (top-mounted)—4/00

Diagram 4 Professional rendering (bottom- mounted)—4/00

Diagram 5 The Swivel Assembly—4/00

Diagram 6 Alternatives to the Y-Axis Split Method (X-Axis, Four Quadrants)—5/00

Diagram 7 Mounting Options—Alternatives to the Gravity Method (Velcro, C-clamp, suction-cup and elastic bands)—5/00

Diagram 8 The Dividing Wall—Alternatives to the Flag/Rod Method (Venetian blind, cardboard, Screen-filter)—5/00

Diagram 9 Collapsible features of my invention—5/00

Diagram 10 New Prototype (main assembly) for Demo Purposes—10/00

Diagram 11 Possible Design Enhancement: “T-bar”—10/00

Diagram 12 Seating Options—Informational Purposes—10/00

Picture 1 Original photographs of item detailed in Diagram 2—12/99

Picture 2 Supplemental photo of prototype—5/00

Picture 3 Printout of a Horizontally Split screen photograph—4/01

Picture 4 Printout of Vertical Split screen from Gran Turismo 3 (my invention is also compatible with racing games)—3/01

Picture 5 “Area 52” top view from Perfect Dark Strategy Guide and hand-drawing from memory (before purchasing guide book). Turn hand-drawing ¼ counter clockwise for a side-by-side comparison.

### DETAILED DESCRIPTION OF THE INVENTION

The following materials were first used in creating this invention: one piece of fence board about 1′ in length (wood), a metal ruler of 36″ in length, an automobile sunshade, some electrical tape and one wooden screw. By applying simple physics, I determined that this invention could be held in place by the force of gravity. I fastened the aforementioned materials together using only the screw and the electrical tape. I first took the piece of wood and placed the ruler perpendicular to it the thickness of the board and screwed the two pieces together. Next, I took the automobile sunshade and taped it securely along the metal ruler, after first folding the sunshade in half. The sunshade would serve as the dividing wall for my invention. The reason for folding the sunshade in half was to create a sturdier dividing wall. By positioning the two wire frames flush together, I was able to stabilize/strengthen the frame in order to enable the wall to remain in an erected state. This also created the most effective and desirable shape for which I could then connect this sunshade to the metal ruler.

[Note: The type of sunshade I used for building my original prototype is different from the folded cardboard versions that most people might be familiar with. This sunshade was made out of the same thin-nylon material (lightweight) that umbrellas are made of. It also had two wire frames built into the shade, corresponding to the driver and passenger side of the automobile. The wire frame allowed the owner/user of the sunshade to twist and fold the shade into a small circle, not much bigger than a dinner plate, for convenient storage. To re-apply the sunshade, all one needed to do was to twist the sunshade from its folded-down state and the wire-frames stretched the thin-nylon to the shape/size of the car's windshield.]

As soon as I was able to tape the sunshade to the metal ruler and apply additional tape for overall strength and durability, I decided this would be my test product. By placing the fence board on top of my television, and the force of gravity prevented the wood from sliding forward. The metal ruler was positioned to cover the middle line of the videogame display. The middle line is best described as the line that separates the center boundary wherein two videogame players' screens appear to touch each other in a multiplayer game format. The auto shade that I taped to the metal ruler was effective at creating a projecting wall or partition in an outward direction, perpendicular to the face of the television screen.

Unfortunately, my original invention proved to be too flimsy. The electrical tape that I used lost its hold on many occasions or would easily pull apart at the slightest touch. I decided I needed to build a better product. After failing in my attempt to use a combination of PVC piping and cardboard, I finally came up with something that was simple to build and very effective (see attached Diagram 2—labeled as the “Avant-Guard as modified”).

In the next modification to this invention, my focus was on durability and aesthetics. My first step was to create the main assembly. Using a miter saw, I cut a piece of 1.5″ by 1″ by 36″ pressed hardwood into one short piece of 8″ and one long piece of 28″. I glued the two pieces together in the shape of an upside-down “L”, connecting both pieces by their 1.5″ surface. In selecting this side for the width/front-face, my prototype was able to cover the middle line of the vertically split-screen display without blocking more than ¾″ on either half of the split-screen videogame display (one-half of 1.5″ is 0.75″, or ¾).

Once the glue had dried, I then took out a ⅜″ wooden drill bit and drilled a hole into the upper portion of the upside down “L” as seen in Diagram 2. This hole would be used to support a wooden dowel, thus creating a lightweight but durable support arm for the dividing wall. To recite an example, this function is similar to how a flagpole supports the weight of a hanging flag from the side of a house.

For the dividing wall, I purchased some black canvas from a clothing store and cut out a square shaped pattern (approximately 30″ by 30″) that I would use as part of the dividing wall. I stapled the ends of the canvas material together creating a tunnel just big enough to allow me to slide the ⅜″ wooden dowel through. With the wooden dowel inserted into this new hole, the device closely resembled a flag at this point of the process. Next, I inserted the wooden dowel into the hole I pre-drilled into the main “L” shaped assembly. I then took a staple gun and attached the inside portion of the black canvas to the wooden assembly. I did this using the same ¼″ staples and a manual staple gun. By stapling the canvas to the wooden main assembly, I prevent the canvas from moving or swaying out of place.

Diagram 10 is essential an enhancement of the design of Diagram 2, but incorporating the swivel mechanism shown in Diagram 5. This is the best mode of manufacture of the three prototypes I built. Please refer to the actual diagram itself for assembly instructions related to Diagram 10. Lastly, please see Exhibit 10 for a sample set of user instructions that I prepared specifically in relation to Diagram 10. The single biggest improvement over this would be the ability to incorporate the weighted-base (more desirable than using Velcro) as portrayed in Diagram 9.

Please note my desire to obtain legal protection over the weighted-base element even though I have yet to construct a workable prototype. This will be a feature that will most likely go into the final design if mass-produced. Without a factory set-up, I am only able to claim this design element in concept form. Hence, the reason why Diagram 9 is not as detailed as many of the other diagrams. Additionally, the portrayal seen in Diagram 5 that refers to a vertical extending/slidable rod and a retractable flag apparatus are also ideas that are only in concept form for reasons just set forth.

This feature prevents either videogame challenger competing in a vertical split-screen multiplayer videogame from being able to see any portion of his/her opponent's screen. Once both competitors take their respective seats in front of the television monitor, neither person should be able to see each other's screen (please refer to Diagram 11 and 12). To work effectively, each competitor must sit a pre-determined distance away from each other. The dividing wall would then block each person's viewing angle such that only his/her private screen could be seen.

One of the last steps, and probably the most critical element for making this product work, was the need to have it suitably attached to the television cabinet for extended use. Because the material I was using was smaller and heavier than my original design, I needed to find a way to prevent the main assembly from falling off the television cabinet. Using Velcro, a fastening tape consisting of a strip of nylon with a surface of minute hooks that fasten to a corresponding strip with a surface of uncut pile, I found a way of connecting the main assembly to the top of my television screen. I cut a 2″ piece of the uncut pile surface fastening strip and taped it to the underside of the main wooden assembly as shown in Diagram 2. Next, I cut a strip of Velcro with the minute hooks to a length of about 1′ and taped this width-wise across the top of my television.

Although it was not the most visually appealing at first, I was able to touch up the look of this product by painting all of the wooden surfaces with a dull-finish black in color. The black color of the Velcro tape also blended well with my television cabinet. With the help of an industrial design firm, the product has been made to look more visually appealing though still capable of the same functionality (see Picture 2). There are several other less effective means of building/using this invention that I wish to seek legal protection for. Diagram 6 contains a picture of a horizontally mounted device that would serve as a means of dividing a horizontal split screen videogame (see Picture 3). In fact, many videogames support a horizontal split screen but this option was determined to be less desirable because it would require the videogame player so position themselves at different eye-levels. I think this would be an overall detriment to the popularity of this product, particularly for the person that is in control of the computer character through the lower half of a split screen display. Another aspect that was considered but ultimately determined to have little cost-benefit value was the ability to have this invention geared for a four-player split screen video display. As seen in Diagram 6 and Picture 4 (a printout of what a four player split screen looks like from an actual videogame).

Diagram 7 contains drawings of various ways in which this invention can be held in place or otherwise connected. These types of connections are less desirable than the gravity harnessing weight-block method (see Diagram 3, 5 and Picture 2) but are still capable of eventually being incorporated into various design alternatives for my invention. As the drawings show, a C-clamp apparatus could be used that is either spring-loaded or connected by tightening either one or more screws (depending on the placement of the clamps and the number of clamps needed). Although it is clear in Diagram 2 that a Velcro strip could be effective when combined with the force of gravity, it is also possible to have the Velcro used as support on the face or sides of the television cabinet. A suction-cup approach and an elastic band approach are also discussed in this Diagram 7. Lastly, the device could be floor-mounted that can be placed in front of the television with a hanging dividing wall.

Diagram 8 contains alternative ways of what the dividing wall might look like. The projecting wall as seen throughout the majority of the attached diagrams is obviously the preferred approach. Mostly because of it is the easier and less expensive way to manufacture this product. Because it is temporarily attached to the television, it shouldn't be considered an eyesore. A more difficult but still effective means of separating the view of either opponent's challenger in multiplayer split screen deathwatch is through many rows/columns of slats, similar to how a Venetian blind is used in homes for blocking sunlight from penetrating into the home. The open/close mechanism would work much in the same way as the swivel assembly described in Diagram 5. A cheap and very simple approach would be to use cardboard and a suction cup gripping method (seen in Diagram 7) as drawn in Diagram 8. This would be a cheap looking device and thus it was determined to be less market worthy compared to the version seen in Picture 2. At this point however, a final version has not been selected even though Picture 2 looks to be the ideal approach. Other materials could be used that are lighter in weight or density.

Another beneficial element of my invention is that it is designed to be a collapsible assembly. This can be accomplished by breaking the device into several parts. For instance, the main portion of the product (see the portion of the device that sits on top of the television in Picture 2) will allow the blinder/dividing wall/partition to be disconnected. Diagram 9 is intended to demonstrate in a visual form how this can be accomplished. Other methods in which various parts/pieces of this invention can be attached/re-attached are also listed in Diagram 9.

1. An externally applied apparatus that provides a first means of partitioning a split screen video game display, thereby providing an adequate measure of privacy for either a one-man or two-person team by blocking the viewing angle of the projected images displayed on each player's individual video game display screen from their opponent's line of sight respectively, comprising:
a. a blinder assembly consisting of a lightweight flag that effectively blocks the viewing angle of one's private screen from their opponent but does not interfere with one's ability to see their own video game display,
b. said flag would be made to create an effective seal between the projected on screen video game split screen display and the said middle line in a split-screen display by way of a pre-determined or adjustable rod placed vertically along the face of the television monitor,
c. a narrow rod would be used to hold the flag in an erect position and adjoined to main assembly for extended use thus comprising the blinder assembly,
d. said flag would consist of material sufficiently opaque so as to make it difficult for the video game player(s) to determine what images appear on their opponent's screen,
e. said main assembly would enable the blinder apparatus to be projected outward at a predetermined distance from the front of a television screen and held into place by the main assembly using a means of attachment,
f. said main assembly would contain a suitably weighted block that could be temporarily placed on top of one's television cabinet so that the fully-assembled apparatus would be held into position by way of rubber feet or other gripping material for extended use,
